(19) United States
(12) Patent Application Publication
(10) Pub. No.: US 2017/0127622 A1
(43) Pub. Date: May 11, 2017

(54) SMART CONTROL/IOT SYSTEM FOR AGRICULTURE ENVIRONMENT CONTROL

(71) Applicant: Xu Hong, San Jose, CA (US)

(72) Inventor: Xu Hong, San Jose, CA (US)

(21) Appl. No.: 14/937,748

(22) Filed: Nov. 10, 2015

(51) Int. Cl. A01G 9/24; A01G 9/20; A01G 1/00; G06F 17/18; H05B 33/08

(52) U.S. Cl. CPC A01G 9/24; G06F 17/18; H05B 33/0815; A01G 1/001; A01G 9/20

(57) ABSTRACT

An Internet-of-Thing (IoT) method for improving ROI of farming includes placing a plurality of sensor hubs in predetermined locations in a farm, each hub including a meteorological data acquisition system and an environmental data collection system; and monitoring key elements in the growing of plants from a plurality of sensor hubs including lighting, humidity, temp, soil moisture, and elements that influence plant growth.

### BACKGROUND

The present application relates to smart control of farming techniques.

Our world is getting larger . . . and hungrier . . . with every tick of the clock.

Indeed, each second the world's population grows by two more people, and by 2050, food production must increase by at least 70 percent to keep pace.

Unfortunately, about half of the world's food is never consumed due to inefficiencies in the harvesting, storage and delivery of crops. Even in developed nations, about 30 percent of purchased food ends up going to waste, and supply-chain inefficiencies only exacerbate the problem.

Certainly, weather-related events—like the current and long-lasting drought in portions of the U.S.—add further complexity to the science of farming, as resultant crop damage, food supply shortages and rising commodities prices frequently illustrate. To help reverse this trend, and to generate enough food to meet the ever-growing demands of a growing global population, today's—and tomorrow's—agribusinesses need to embrace smarter farming methods.

### SUMMARY

In one aspect, an Internet-of-Thing (IoT) system improves ROI of farming by monitoring predetermined elements in the growing of plants. The system collects data from a sensor hub which includes a meteorological data acquisition system and an environmental data collection system. The system also monitors elements (lighting, humidity, temp, soil moisture, etc . . . ) that influence plant growth.

In another aspect, an Internet-of-Thing (IoT) method for improving ROI of farming includes placing a plurality of sensor hubs in predetermined locations in a farm, each hub including a meteorological data acquisition system and an environmental data collection system; and monitoring key elements in the growing of plants from a plurality of sensor hubs including lighting, humidity, temp, soil moisture, and elements that influence plant growth.

Advantages of the system may include one or more of the following. The system provides a Multi Channel wavelength Smart control design that enables researcher and grower to setup and optimize the efficiency of lighting receipt, and additionally to dim, shutdown and turn off the bright/darkness cycle in order to provide effective PPFD during the bright and dark period. The computer systems and controllers are capable of permitting farmers and farming business to exercise extremely precise control over almost every aspect of a farming operation, such as fertilizing, planting, spraying or harvesting crops.

### BRIEF DESCRIPTION OF THE DRAWINGS

The invention will be understood by the following detailed description in conjunction with the accompanying drawings, wherein like reference numerals designate like structural elements, and in which:

FIG. 1 shows an exemplary architecture for smart farming.

FIG. 2 shows an exemplary system architecture for SMART Control Environment Agriculture.

FIG. 3A shows in more detail an exemplary sensor hub.

FIG. 3B shows exemplary data flow from the sensor hub to the cloud.

FIG. 4 shows an exemplary five channel lighting control.

FIG. 5 shows an exemplary system with multi-frequency lighting zones.

FIGS. 6A-6B show an exemplary Multi Wavelength LED Array and Chips-On-Board (COB) layout.

FIG. 7 shows exemplary web-based control of the lighting system.

### DESCRIPTION

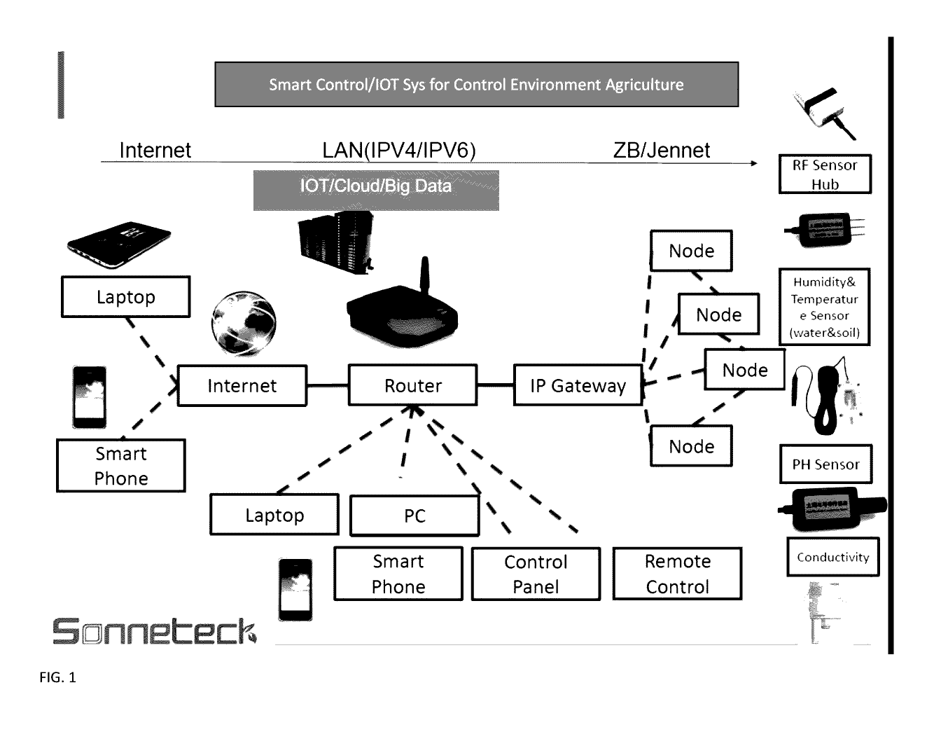

FIG. 1 shows an exemplary architecture for smart farming. The system can provide Control Environment Agriculture (Greenhouse; Plant Factory; Growing Container) and Vertical farming. Radio frequency (RF) sensor hubs, along with humidity, temperature, pH, conductivity, Cot, photon quantum, flux, sensor nodes both in air and water (hydroponic), Medium (soil or Nutrient Medium) capture information and rely the information to an Internet Protocol (IP) gateway. The IP gateway communicates with a router information to the Internet. The router also communicates with laptops, computers, smart phones, local control panels, and remote control panels. The data can be streamed over the Internet to servers for IoT/Cloud/Big Data analysis and optimizing the growing model through best practices from researcher and grower. The information can also be accessed by remote laptops and smart phones, among others.

The IOT system improves ROI, food quality and security of farming by monitoring key elements in the growing of plants. It collects data from sensor hub which includes a meteorological data acquisition system and an environmental data collection system. Base on the real-life result, the SMART system will monitor elements (lighting, humidity, temp, soil moisture, etc . . . ) that have influences on plants growing.

The computer systems and related technology permits farming businesses to program the farming equipment to carry out farming operations almost entirely under automated control of software programs that can automatically activate and deactivate the machines, and even particular sections, row units, nozzles or blades on the implement at precisely the right time and place in order to optimize inputs such as seed, pesticide and fertilizer, and thereby achieve greater yields. During the course of performing farming operations, the computer systems and technology onboard the farming vehicles and farming implements typically transmit, receive and respond to electronic messages containing an enormous amount of very detailed operational data that describes almost every aspect of the farming operation. For example, if the farming vehicle and the farming implement used during a farming operation are a tractor and a sprayer, respectively, then the tractor and the sprayer will use the onboard computer systems and computer network to exchange and respond to a large number of messages that include critical operating parameters for the sprayer, such as, among other things, the sprayer's on/off status, working width, x-offset (i.e., driving direction), y-offset, target rate, application rate, master valve on/off status, total volume of spray applied, total area sprayed, total distance driven and total time used. It would be extremely useful to capture, store, analyze and share these operating parameters. A farmer could use this information, for example, to determine and compare what resources were used, where, and with what settings, and a seed company could study and use the information to improve seed product yields.

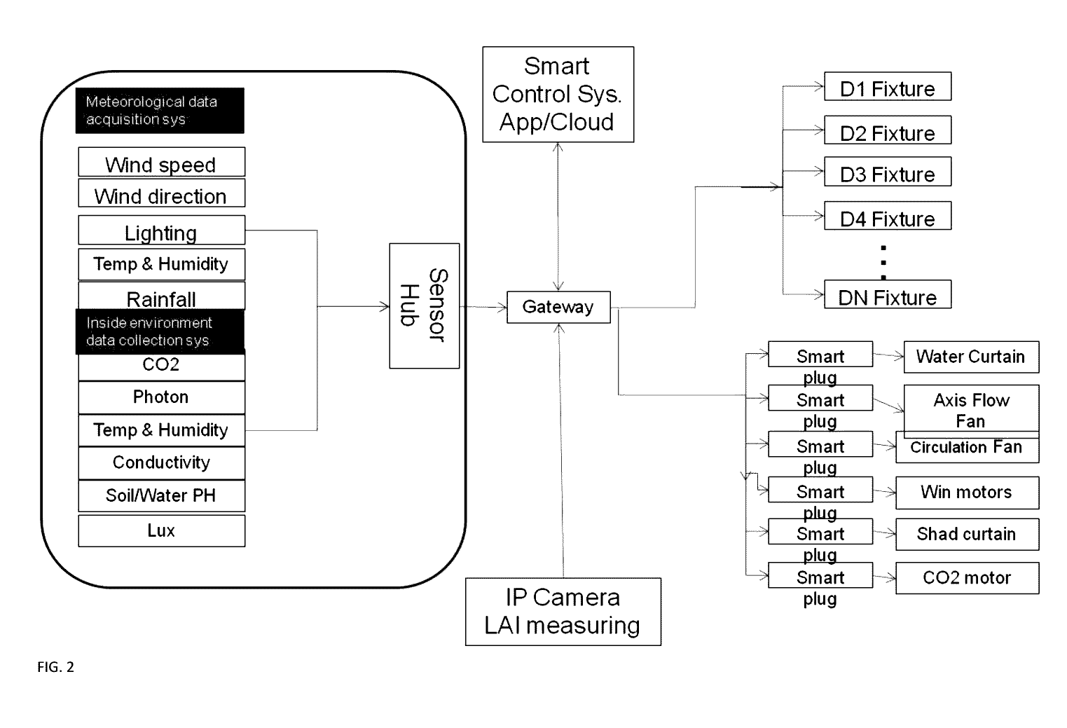

FIG. 2 shows an exemplary system architecture for SMART Control Environment Agriculture. In this system, a meteorological data acquisition system captures wind speed and direction, lighting, temperature, humidity and rainfall. The system also includes a local (inside farm) environment data collection system that captures CO2, photons, temperature, humidity, conductivity, soil/water pH, and lux data. All data is provided to a sensor hub that communicates with a gateway. One or more IP cameras can be connected to the gateway for Leaf Area Index (LAI) measuring. A motion sensor also could added on top of light if multi channel wavelength including UV to shut down UV while people working there to provide biologic safety setup. A smart control system application, web server, or cloud server can communicate with the gateway. Similarly a plurality of fixtures D1 . . . DN are provided to capture plant data and communicate through the gateway. Additionally, a plurality of smart plugs receive water flow, fan axis flow, fan circulation, window motors, shadow curtain motors, and CO2 motors. The information is captured by the smart plugs and communicated through the gateway.

Spatial variation is at the core of precision agriculture and geostatistics. All aspects of the environment—soil, rocks, weather, vegetation, water, etc.—vary from place to place over the Earth. The soil, landform, drainage, and so on all affect crop growth, and these factors generally vary within agricultural fields. Farmers have always been aware of this situation, and with the sensor hubs can now measure and map it in a quantitative way. Measurement is now possible with the tools provided by geostatistics, which describes how properties vary within fields. This information is then used to predict values at places where there is no information for eventual mapping. Geostatistics can also be used to design sampling of the soil and crops to determine what the soil needs to improve crop growth, in terms of crop nutrients, lime and irrigation, for example. This sample information is used for geostatistical prediction and mapping. Such maps can then be used by farmers for decision-making. Examples include where to apply lime in a field, where more water or drainage is needed, and what amounts of nutrients are required in different parts of a field. Precision agriculture will reduce the amount of fertilizers and pesticides used by applying inputs only where they are needed and in appropriate quantities. With Multi Channel Smart control System, the system enable researcher and grower not only to setup and optimize the efficiency of lighting receipt but also to dim, shutdown and turn off the bright/darkness cycle in order to provide effective PPFD during the bright and dark period to establish the total own effectiveness energy saving sys for agriculture—both plant and poultry vertical farming.

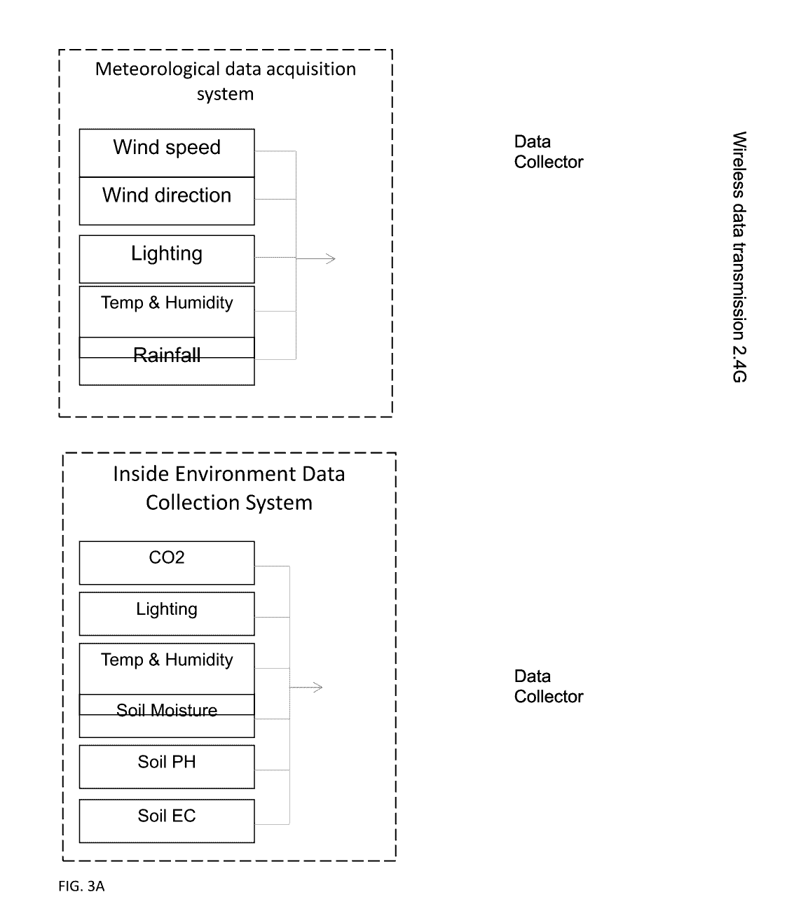

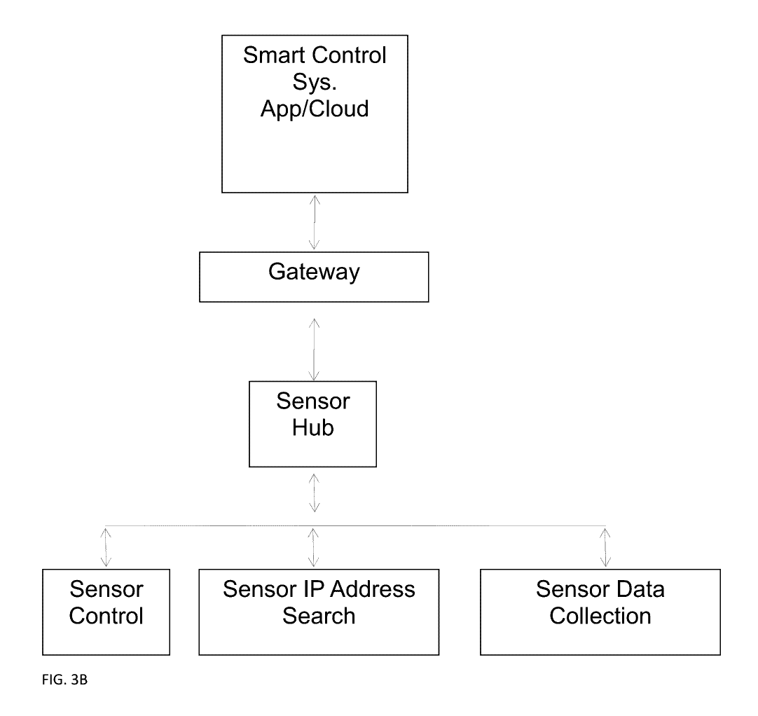

FIG. 3A shows in more details an exemplary sensor hub. The hub includes a meteorological data acquisition system that captures wind speed and direction, lighting, temperature, humidity and rainfall, and the data is saved in a data collector. The system also includes a local (inside farm) environment data collection system that captures through another data collector information on CO2, photons, temperature, humidity, conductivity, soil/water pH, and lux. Data captured by the sensor hub data collectors is communicated over a wireless data transmission device that communicates with the gateway using WiFi or cellular channels, for example. The deviation between meteorological and indoor environment data will plan and calculating by computer to decide which implement action instruction should sent to sys to achieve the highest energy saving results, for examples, open the window to get fresh air indoor to drop the temperature, increase the CO2 concentration instead of turn on the AirCon and CO2 motor

FIG. 3B shows exemplary data flow from the sensor hub to the cloud. In this embodiment, the sensor hub is controlled by a sensor control. The control can be responsive to an IP address search for the sensor hub, and the sensor hub can provide data collection responsive to a query to the sensor hub from a smart control system (application or cloud based) through the gateway.

In one embodiment, the system can determine, using images captured by the IP module, a Leaf Area Index (LAI) measurement. One embodiment determines

T(θ, α)=Pₛ/(Pₛ+Pₙₛ)

where T(θ, α) is the gap fraction for a region with zenith angle θ and azimuth angle α; Ps is the number of pixels sky in a region (θ, α) and Pns is the number of pixels vegetation in a region (θ, α).

Light extinction models can be used as the probability of interception of radiation within canopy layers, as well as the probability of sun flecks at the bottom of the canopy. Sun flecks correspond to gaps in the canopy when viewed along the direction of the direct solar beam. One embodiment assumes a random spatial distribution of the canopy that requires a Poisson model, assuming that projections of leaves are randomly located in the plane of the projection. The Poisson model divides the canopy in N statistically independent horizontal layers in which leaves are uniformly and independently spread. These layers are sufficiently thin (ÄL=LAI/N) to make the probability of having more than one contact between incoming light rays and vegetation within one layer small compared to the probability for one contact. The probability of a contact.

$$EVI = G * \frac{{ρ}_{NIR} - {ρ}_{Red}}{{ρ}_{NIR} * {C}_{1} * {ρ}_{Red} - {C}_{2} * {ρ}_{Blue} + L}$$

$$where , \\ {ρ}_{NIR} = NIR Reflectance$$

$${ρ}_{Red} = Red Reflectance$$

$${ρ}_{Blue} = Blue Reflectance$$

$${C}_{1} = Atmosphere Resistance Red Correction Coefficient$$

$${C}_{2} = Atmosphere Resistance Blue Correction Coefficient$$

$$L = Canopy Background Brightness Correction Factor$$

$$G = Gain Factor$$

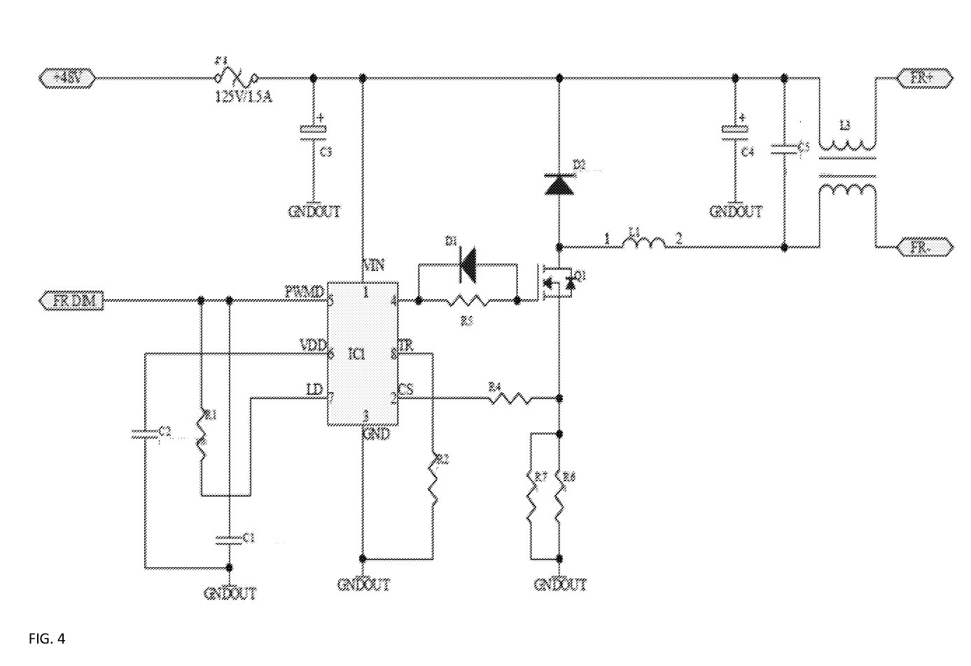

In another embodiment, a SMART lighting Control System is provided. A Multi Channel control is used to independently control each effective wavelength of Light for Agriculture to build unique lighting receipt to improve ROI both for quality and quantity of foods. FIG. 4 shows an exemplary five channel lighting control. In one embodiment, the total channel number can be 12 channels.

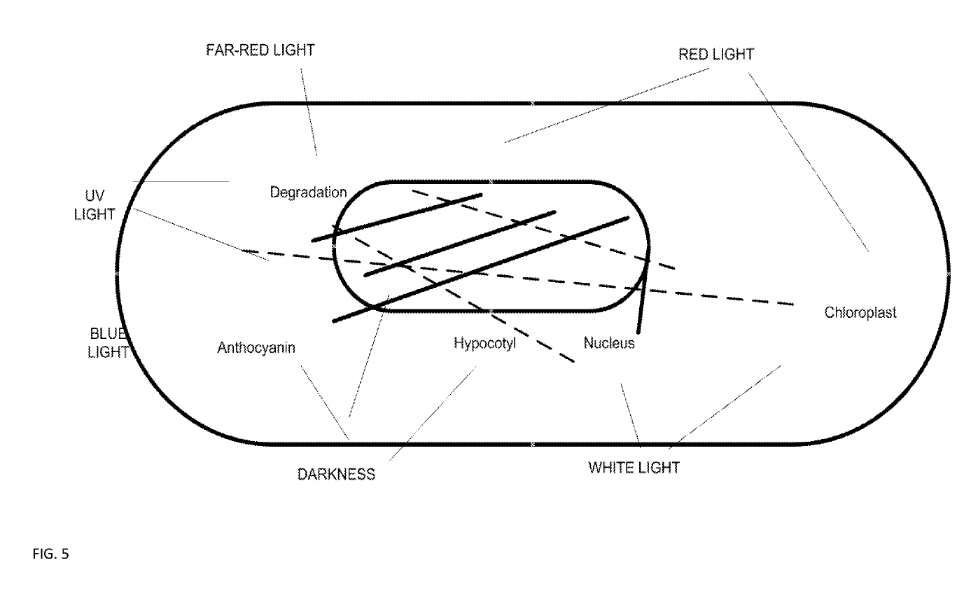

FIG. 5 shows an exemplary system with multi-frequency lighting zones, each can be controlled by the system of FIG. 1 and optimized to plant requirements. Wavelength Identified as effective for horticulture growing as following
Channel 1: 730 nm+/−20 nm
Channel 2: 660 nm+/−20 nm
Channel3: 640 nm+/−20 nm
Channel4: 530 nm+/−20 nm
Channel5: 505 nm+/−20 nm
Channel6: 468 nm+/−20 nm
Channel17: 450 nm+/−20 nm
Channel18: 380 nm+/−20 nm
Channel19: 300 nm+/−20 nm
Channel10: 6500 K Cool White CRI80
Channel11: 3000 K Warm White CRI80
Channel12: others

With Multi Channel Smart control System design, enable researcher and grower to setup and optimized the effective of lighting receipt but also dimming and shutdown or turn off the bright/darkness cycle to provide effective PPFD during the bright and dark period.

### Lighting Receipt

for any leaf vegetable, lighting receipt is

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 1 | 1 | 0 |
| UVA | 380 +/− 20 nm | 1 | 0 | 1 |
| Blue | 450 +/− 20 nm | 1 | 1 | 1 |
| R | 640 +/− 20 nm | 2 | 0 | 2 |
| DR | 660 +/− 20 nm | 4-6 | 4-6 | 4-6 |
| FR | 730 +/− 20 nm | 1 | 1 | 0 |
| White | 6000K +/− 500K | 1 | 1 | 1 |

for Solanaceous Fruit/Vegetable.

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 1 | 1 | |
| UVA | 380 +/− 20 nm | 1 | 0 | 0 |
| Blue | 450 +/− 20 nm | 1 | 1 | 1 |
| R | 640 +/− 20 nm | 2 | 0 | 2 |
| DR | 660 +/− 20 nm | 7-10 | 7-10 | 7-10 |
| FR | 730 +/− 20 nm | 2 | 2 | 2 |
| White | 6000K +/− 500K | 1 | 1 | 0 |

for Tubes Vegetable.

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 1 | 1 | 0 |
| UVA | 380 +/− 20 nm | 1 | 0 | 0 |
| Blue | 450 +/− 20 nm | 4-6 | 4-6 | 4-6 |
| DR | 660 +/− 20 nm | 2 | 2 | 2 |
| FR | 730 +/− 20 nm | 2 | 2 | 2 |
| White | 6000K +/− 500K | 1 | 1 | 0 |

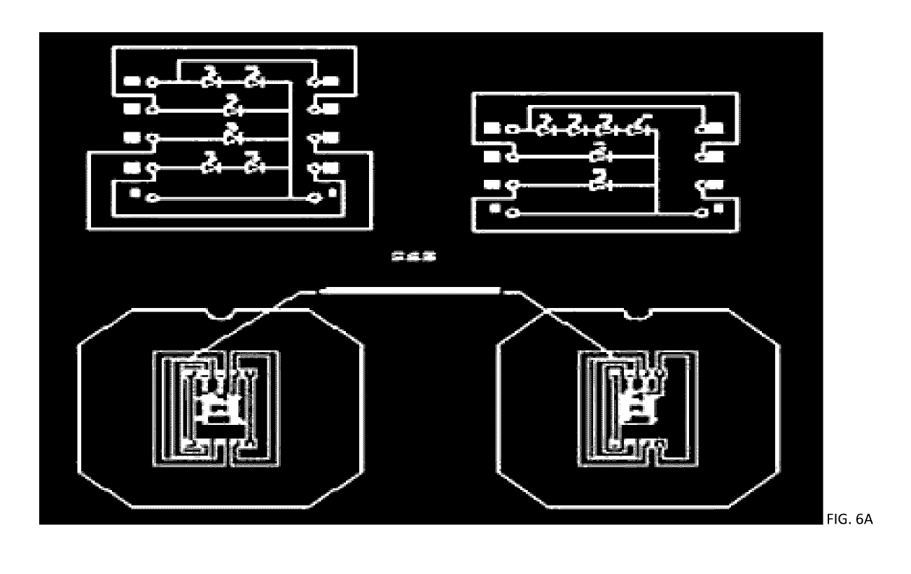

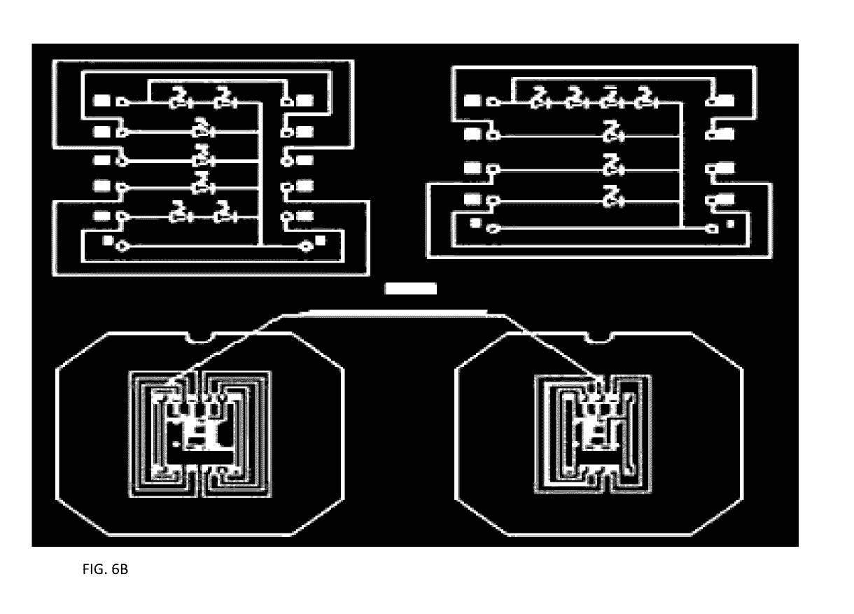

FIGS. 6A-6B show an exemplary Multi Wavelength LED Array and COB. In one embodiment, the channel Vf is about 36V+/−3V and the channel can be used for grouping or non grouping control. While FIG. 6 shows 2 channels, the system can extend to 12 channels or more.

The lighting control can be pulse width modulation (PWM). A Pulse Driver is provided for setting and controlling of PWM Solution/Program. The pulse radiation method model not only helps energy saving, but also extends system lifespan and accelerates the plant growing cycle. In one embodiment, the PWM can have a frequency range: 0-62.5 KHz. Programming can be done by PWM control solution setting and control by App/Cloud. For example, the PWM can be embedded by firmware as below:

| | | | |
|---|---|---|---|
| 101 | #define LAMP_LEVEL_MAX | 255 | /* Max value for level */ |
| 102 | #define LAMP_LEVEL_MIN | 16 | /* Min value for level */ |
| 103 | | | |
| 104 | //#define PLUS_STEP | 20 | |
| 105 | #define PLUS_STEP | 5 | |
| 106 | | | |
| 107 | #define BULD_TIMER_FREQUENCY | 250000 | /*Timer clock frequency */ |
| 108 | #define BULB_TIMERO_PRESCALE | 6 | //976.5625Hz |
| 109 | #define BULB_TIMElll_PRESCALE | 7 | //488.28125Hz |

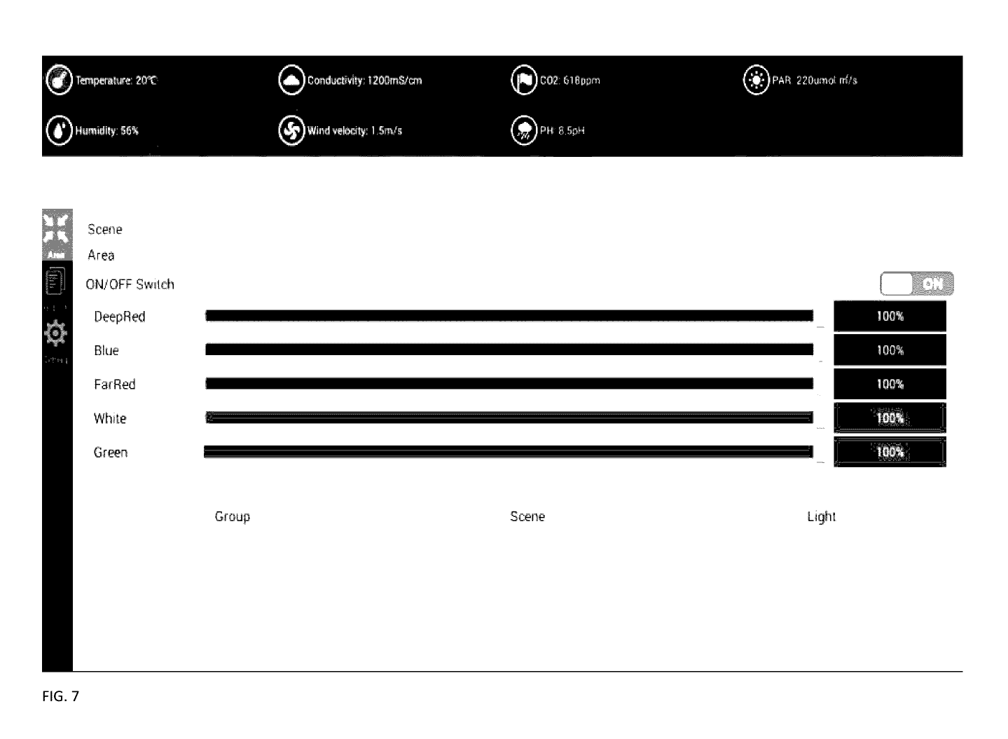

FIG. 7 shows exemplary web-based control of the lighting. On top, growth parameters such as temperature, soil conductivity, CO2, PAR, humidity, wind flow, and pH are displayed. The system allows selective control of each LED, each glowing at a predetermined visible light region. The light can be individually turned on and off.

The Smart Control/IOT Sys for Control Environment Agriculture with Sensor Hub provides real-life feedback information analyze and change, allowing users to control system anytime and anyplace. System especially focus on the fields present below (Greenhouse; Plant Factory; Growing Container) & Vertical farming

Multi Channel independently to control each effective wavelength of Light for Agriculture to build unique lighting receipt to improve ROI both for quality and quantity of foods

With Multi Channel Smart control System design, enable researcher and grower to setup and optimized the effective of lighting receipt but also dimming and shutdown or turn off the bright/darkness cycle to provide effective PPFD during the bright and dark period. The pulse radiation method model is not only help for energy saving, extend sys lifespan but also accelerate the plant growing cycle.

Although summarized above as a PC-type implementation, those skilled in the art will recognize that the one or more controllers 330 also encompasses systems such as host computers, servers, workstations, network terminals, and the like. In fact, the use of the term controller 330 is intended to represent a broad category of components that are well known in the art.

Aspects of the systems and methods provided herein encompass hardware and software for controlling the relevant functions. Software may take the form of code or executable instructions for causing a controller, hub, or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory 380, such as main memory 380 of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. An Internet-of-Thing (IoT) enabled method for improving ROI of farming, comprising placing a plurality of sensor hubs in predetermined locations in a farm, each hub including a meteorological data acquisition system and an environmental data collection system; and
monitoring key elements in the growing of plants from a plurality of sensor hubs including lighting, humidity, temp, soil moisture, and elements that influence plant growth.

2. The method of claim 1, comprising providing lighting control including dim, shutdown and turn off the bright/darkness cycle in order to provide effective PPFD during the bright and dark period.

3. The method of claim 1, comprising capturing visual farm data using a camera.

4. The method of claim 1, comprising streaming visual farm data to a remote computer.

5. The method of claim 3, comprising measuring Leaf Area Index (LAI).

6. The method of claim 1, comprising determining
T(θ, α)=P_{z}/(Pₛ+Pₙₛ)
where T(θ, α) is the gap fraction for a region with zenith angle θ and azimuth angle α; Ps is the number of pixels sky in a region (θ, α) and Pns is the number of pixels vegetation in a region (θ, α).

7. The method of claim 1, comprising applying light extinction models.

8. The method of claim 1, comprising determining probability of interception of radiation within canopy layers and probability of sun flecks at the bottom of the canopy, wherein sun flecks correspond to gaps in the canopy when viewed along the direction of a direct solar beam.

9. The method of claim 1, comprising determining
$$EVI = G * \frac{{ρ}_{NIR} - {ρ}_{Red}}{{ρ}_{NIR} * {C}_{1} * {ρ}_{Red} - {C}_{2} * {ρ}_{Blue} + L}$$
$$where , \\ {ρ}_{NIR} = NIR Reflectance$$
$${ρ}_{Red} = Red Reflectance$$
$${ρ}_{Blue} = Blue Reflectance$$
$${C}_{1} = Atmosphere Resistance Red Correction Coefficient$$
$${C}_{2} = Atmosphere Resistance Blue Correction Coefficient$$
$$L = Canopy Background Brightness Correction Factor$$
$$G = Gain Factor$$

10. The method of claim 1, comprising, for a leaf vegetable, providing lighting receipt as:

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 10-10 | 10-10 | 0-10 |
| UVA | 380 +/− 20 nm | 10-10 | 0-10 | 10-10 |
| Blue | 450 +/− 20 nm | 10-10 | 10-10 | 10-10 |
| R | 640 +/− 20 nm | 20-10 | 00-10 | 20-10 |
| DR | 660 +/− 20 nm | 4-60-10 | 4-60-10 | 4-60-10 |
| FR | 730 +/− 20 nm | 10-10 | 10-10 | 00-10 |
| White | 6000K +/− 500K | 10-10 | 10-10 | 10-10 |

11. The method of claim 1, comprising for a Solanaceous Fruit/Vegetable, providing lighting receipt as:

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 1 | 1 | |
| UVA | 380 +/− 20 nm | 1 | 0 | 0 |
| Blue | 450 +/− 20 nm | 1 | 1 | 1 |
| R | 640 +/− 20 nm | 2 | 0 | 2 |
| DR | 660 +/− 20 nm | 7-10 | 7-10 | 7-10 |
| FR | 730 +/− 20 nm | 2 | 2 | 2 |
| White | 6000K +/− 500K | 1 | 1 | 0 |

12. The method of claim 1, comprising for tubes vegetable, providing lighting receipt as:

| | | | | Radiation |
|---|---|---|---|---|
| | | Radiation | Radiation | power |
| | Peak | power | power | (mw) |
| | wavelength | (mw) (ratio) | (mw) (ratio) | (ratio) |
| UVB | 300 +/− 20 nm | 1 | 1 | 0 |
| UVA | 380 +/− 20 nm | 1 | 0 | 0 |
| Blue | 450 +/− 20 nm | 4-6 | 4-6 | 4-6 |
| DR | 660 +/− 20 nm | 2 | 2 | 2 |
| FR | 730 +/− 20 nm | 2 | 2 | 2 |
| White | 6000K +/− 500K | 1 | 1 | 0 |

13. The method of claim 1, comprising providing a Multi Wavelength LED Array and COB. T

14. The method of claim 13, wherein Channel Vf comprises 36V+/−3V and the channel can be used for grouping or non grouping control.

15. The method of claim 1, comprising providing 12 channels of light control.

16. The method of claim 1, comprising controlling lighting with pulse width modulation (PWM).

17. The method of claim 1, wherein a Pulse Driver is provided for setting and controlling of PWM.

18. The method of claim 17, wherein the PWM comprises a frequency range: 0-62.5 KHz.

19. The method of claim 17, comprising providing a PWM control solution setting and control by App/Cloud.

20. The method of claim 1, comprising providing lighting receipt for a leaf vegetable with a radiation power (mw) ratio between 10-10.
